(19) United States
(12) Patent Application Publication
(10) Pub. No.: US 2025/0344686 A1
(43) Pub. Date: Nov. 13, 2025

(54) Blue Sticky Fly Glue Board with Black Lines

(71) Applicant: Florida Insect Control Group LLC, Gainesville, FL (US)

(72) Inventors: Philip G. Koehler, Gainesville, FL (US); Enrico Paolo Levi, Modena (IT)

(21) Appl. No.: 19/279,689

(22) Filed: Jul. 24, 2025

Related U.S. Application Data
(63) Continuation-in-part of application No. 18/650,815, filed on Apr. 30, 2024.
(60) Provisional application No. 63/463,456, filed on May 2, 2023.

(51) Int. Cl. A01M 1/14; A01M 1/10

(52) U.S. Cl. CPC A01M 1/14; A01M 1/106

(57) ABSTRACT

Systems, devices, and methods for providing a calendar configuration for a multi-sheet fly trap, with each sheet having a sticky exposed surface of a plastic or paper sheet, which is exposed when the covering sheet is removed, each sheet includes patterns of spaced apart black lines over a blue colored surface. The black lines sized to emulate cracks or surface edges to attract the flies thereon. And the sticky sheets can be left up for a period of time from a day to a month, and then be ripped off and discarded. Black line patterns can include different black feather patterns, such as different size rectangle crack shapes, parallelogram crack shapes, curve/crescent crack shapes, and other geometrical crack shapes. The blue colored surface can be an existing blue colored base layer. Additionally, the blue colored layer can be formed from a blue glue surface layer on a base. The black line crack patterns can exist on a base, and the blue glue surface can be applied over the black line crack patterns. The blue glue can be formed from liquid glue with dyes having a color of Pantone 115-5C blue color, where the blue glue remains in a sticky state after being applied. A peel and stick layer can be applied over the blue glue surface. An alternative version can include separately affixing black line crack patterns over a blue glue surface. And a peel and stick layer added thereon.

### CROSS REFERENCE TO RELATED APPLICATIONS

This application is a Continuation in Part of U.S. patent application Ser. No. 18/650,815 filed Apr. 30, 2024, which claims the benefit of priority to U.S. Provisional Application Ser. No. 63/463,456 filed May 2, 2023. the entire disclosure of each of these applications listed in this paragraph are incorporated herein by specific reference thereto.

### FIELD OF INVENTION

This invention relates to fly traps, and in particular to systems, devices, and methods for providing a calendar configuration for a multi-sheet fly trap, with each sheet having a sticky exposed surface on a plastic or paper sheet, which is exposed when the covering sheet is removed, and each sheet having patterns of spaced apart black lines over a blue surface, which the black lines sized to emulate cracks or surface edges to attract the flies thereon, and the sticky sheets can be left up for a period of time from a day to a month, to a year, and then be ripped off and discarded.

### BACKGROUND AND PRIOR ART

Sticky fly paper has been available for over a century. See for example, U.S. Pat. No. 417,400 to Thum, which was granted in 1889. However, these traditional sticky fly papers are restricted primarily to a single sheet/board having a sticky surface that when exposed causes flies that are on the sticky surface to become trapped.

Traditional sticky fly paper uses a uniform colored surface as the sticky surface, which generally only works when the flies land on the sticky surface or fly close to the sticky surface. Additionally, the prior art is limited to a one time use for the sticky paper, and not to plural stackable sticky fly paper applications.

One of the subject inventors developed a “Fly Attractant System with Toxicant Treated Cords” in U.S. Pat. No. 9,089,121 to Diclaro, II et al., which is incorporated by reference. However, this device used black cords that were treated with toxicants over a blue colored background, and was NOT used to trap live insects. Instead, this device used the toxicant treated cords to kill the insects with insecticidal bait.

Thus, the need exists for solutions to the above problems with the prior art.

### SUMMARY OF THE INVENTION

A primary objective of the present invention is to provide a calendar configuration for a multi-sheet fly trap, with each sheet having a sticky exposed surface on a plastic or paper sheet, which is exposed when the covering sheet is removed, and each sheet having patterns of spaced apart black lines over a different color surface, with the black lines sized to emulate cracks or surface edges to attract the flies thereon, and the sticky sheets can be left up for a period of time from a day to a month, and then be ripped off and discarded.

A preferred embodiment includes grids of black lines over a blue colored background on each sheet, having a sticky surface. And a peelable layer over each sticky surface.

Further objects and advantages of this invention will be apparent from the following detailed description of the presently preferred embodiments which are illustrated schematically in the accompanying drawings.

### BRIEF DESCRIPTION OF THE FIGURES

The drawing figures depict one or more implementations in accord with the present concepts, by way of example only, not by way of limitations. In the figures, like reference numerals refer to the same or similar elements.

FIG. 1 is a first embodiment showing a grid pattern for a single sticky surface sheet for a calendar shaped configuration for the blue sticky fly glue board with black lines.

FIG. 2 is a second embodiment showing a plural parallel vertical spaced apart line pattern for a single sticky surface sheet for a calendar shaped configuration for the blue sticky fly glue board with black lines.

FIG. 3 is a third embodiment showing a plural horizontal spaced apart line pattern for a single sticky surface sheet for a calendar shaped configuration for the blue sticky fly glue board with black lines.

FIG. 4 is a bar graph of the results of a 2021 Fly Capture Experiments.

FIG. 5A shows an image of black line pattern over blue background used in the 2021 Capture Experiments.

FIG. 5B shows an image of black line pattern over a yellow background used in the 2021 Capture Experiments.

FIG. 6 is a bar graph of the results of a 2022 Fly Capture Experiments.

FIG. 7A shows an image of white line pattern over a black background used in the 2022 Capture Experiments.

FIG. 7B shows an image of blue line pattern over a yellow background used in the 2022 Capture Experiments.

FIG. 7C shows an image of black line pattern over a yellow background used in the 2022 Capture Experiments.

FIG. 8 shows a first embodiment of a feathering crack pattern in black over a blue background.

FIG. 9 shows a second embodiment of a feathering crack pattern in black over a blue background.

FIG. 10 shows a third embodiment of a feathering crack pattern in black over blue background.

### DESCRIPTION OF THE PREFERRED EMBODIMENTS

Before explaining the disclosed embodiments of the present invention in detail it is to be understood that the invention is not limited in its applications to the details of the particular arrangements shown since the invention is capable of other embodiments. Also, the terminology used herein is for the purpose of description and not of limitation.

In the Summary above and in the Detailed Description of Preferred Embodiments and in the accompanying drawings, reference is made to particular features (including method steps) of the invention. It is to be understood that the disclosure of the invention in this specification does not include all possible combinations of such particular features. For example, where a particular feature is disclosed in the context of a particular aspect or embodiment of the invention, that feature can also be used, to the extent possible, in combination with and/or in the context of other particular aspects and embodiments of the invention, and in the invention generally.

In this section, some embodiments of the invention will be described more fully with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will convey the scope of the invention to those skilled in the art. Like numbers refer to like elements throughout, and prime notation is used to indicate similar elements in alternative embodiments.

Other technical advantages may become readily apparent to one of ordinary skill in the art after review of the following figures and description.

It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Unless otherwise specifically noted, articles depicted in the drawings are not necessarily drawn to scale.

Although specific advantages have been enumerated above, various embodiments may include some, none, or all of the enumerated advantages.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps.

Additionally, steps may be performed in any suitable order. As used in this document, “each” refers to each member of a set or each member of a subset of a set.

The embodiments describe different versions of a calendar configuration of a plurality of glue boards and/or sticky sheets with different patterns of black lines over a colored background having a sticky surface.

For example, each sheet or board can be formed from paper or plastic with a surface having a solid blue color, printed with black lines. The entire surface of one side, can be covered with a sticky glue surface, so that the one side becomes a sticky fly trap.

Flies are attracted to the color blue with black lines.

Flies approach the blue and either think the black area is a crack or edge of a surface. So, the flies will then land on the blue right next to the black lines

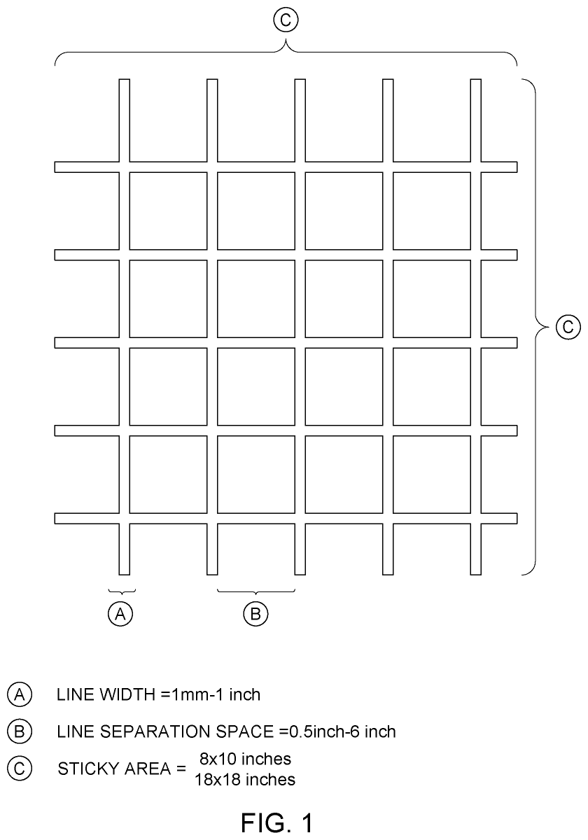

FIG. 1 is a first embodiment showing a black line grid pattern for a single sticky surface sheet for a calendar shaped configuration for the blue sticky fly glue board with black lines.

The grid pattern can include individual black lines A, each having a line width of approximately 1 mm to approximately 1 inch. The separation space B, between the black lines can be between approximately 0.5 inches to approximately 6 inches.

The sticky surface area for each sheet/board can be approximately 8 inches by approximately 10 inches.

Additionally, the sticky surface area C, for each sheet/board can be approximately 18 inches by approximately 18 inches.

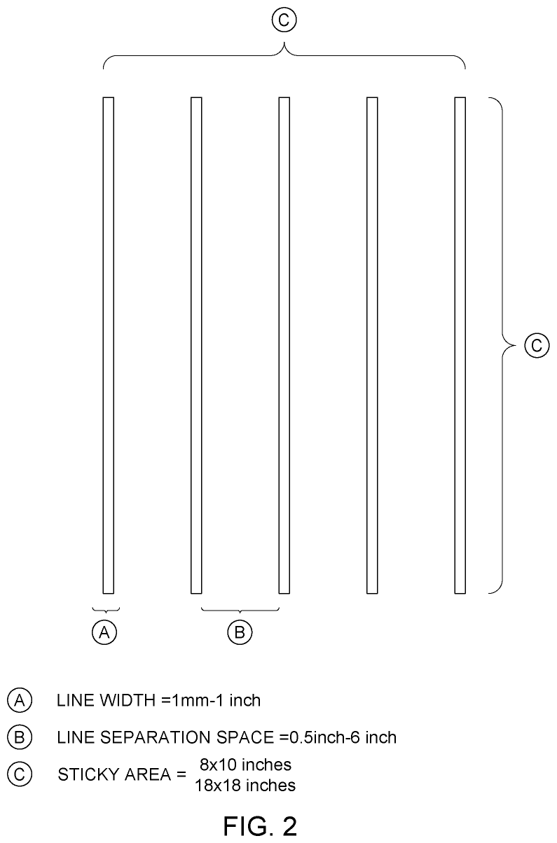

FIG. 2 is a second embodiment showing a plural parallel vertical spaced apart black line pattern for a single sticky surface sheet/board for a calendar shaped configuration for the blue sticky fly glue board with black lines.

Each black line can have a width A, between approximately 1 mm to approximately 1 inch. The separation space B, between the lines can be between approximately 0.5 inches to approximately 1 inch.

The sticky surface area C for each sheet/board can be approximately 8 inches by approximately 10 inches.

Additionally, the sticky surface area for each sheet can be approximately 18 inches by approximately 18 inches.

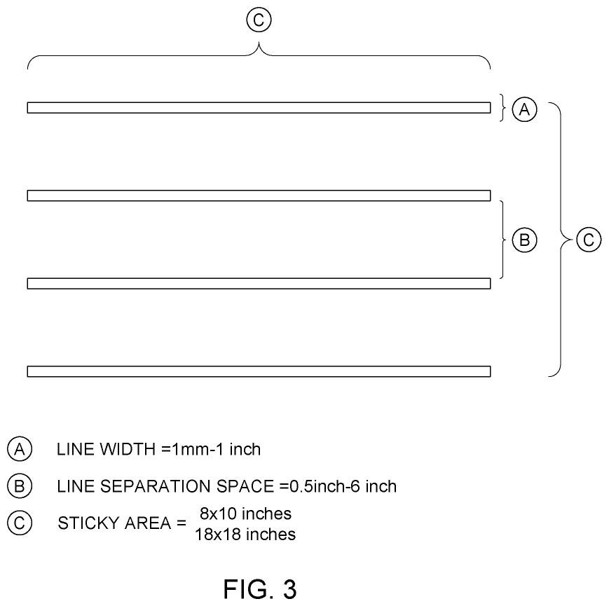

FIG. 3 is a third embodiment showing a plural horizontal spaced apart black line pattern for a single sticky surface sheet/board for a calendar shaped configuration for the blue sticky fly glue board with black lines.

Each black line can have a width A, between approximately 1 mm to approximately 1 inch. The separation space B, between the lines can be between approximately 0.5 inches to approximately 1 inch.

The sticky surface area C for each sheet/board can be approximately 8 inches by approximately 10 inches.

Additionally, the sticky surface area for each sheet can be approximately 18 inches by approximately 18 inches.

The fly catching trap can be in the form of a flip calendar that exposes one sheet/board at a time and is hung on a wall or set on a table/desk.

The calendar images on each page, can be individual dates, and/or individual days of the week, and/or a single week, a single month, a plurality of months, an entire year, and the like.

The calendar images can be black lines and/or black line patterns, with a blue glue background between each of the black lines, or a blue glue background between each of the horizontal and vertical black lines of the black line patterns.

The invention can be inserted into a fly light trap or inserted into a frame to be hung on a wall.

Each sheet/board can be for a selected period of time, such as but not limited to one day, one week, one month, a year, and the like.

Each sticky surface can include a peelable cover sheet, that when removed exposes the sticky surface. The peelable sheet can include, but is not limited to plastic sheath, wax paper, and the like.

Blue Sticky trap experiments were done on Jun. 9, 2021, at a screenhouse at the University of Florida, Gainesville, Florida

About 300 house flies were released into an outdoor large screened house (the screened house contained the flies in an approximately 15 by approximately 10 ft area.

The flies were left to acclimatize to the screened house for approximately 1 hour.

Colored sticky boards were hung on one of the screened walls of the room. Boards were either blue with black lines, yellow with black lines, or Black with white lines.

Boards were left to capture flies in the glue for approximately 2 hours.

Numbers of flies capture in approximately 2 hours were recorded.

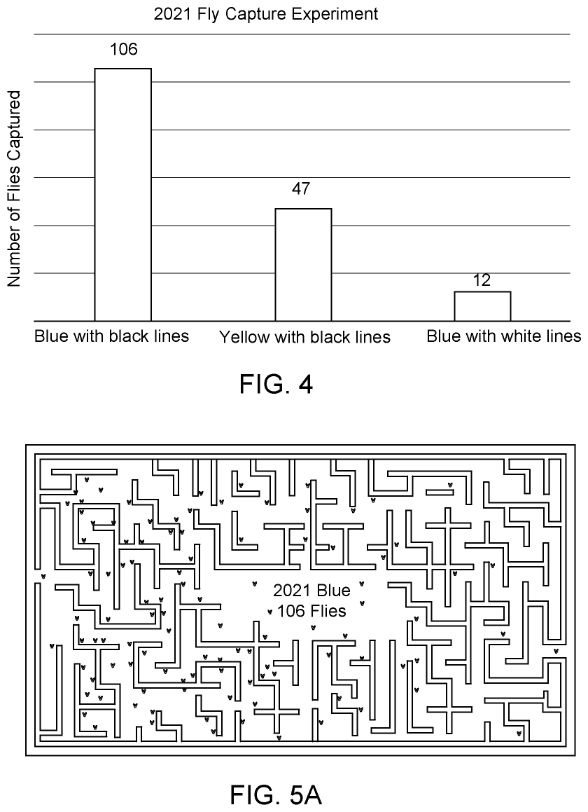

FIG. 4 is a bar graph of the results of a 2021 Fly Capture Experiment.

A total of 106 flies were caught on the blue with black lines board.

A total of 47 flies were caught on the yellow with black lines board,

A total of 12 flies were caught on the black with white lines board.

A comparison of Blue with Black lines captured shows that 2.3 times more flies than yellow with black lines, and 8.8 times more flies than Black with white lines.

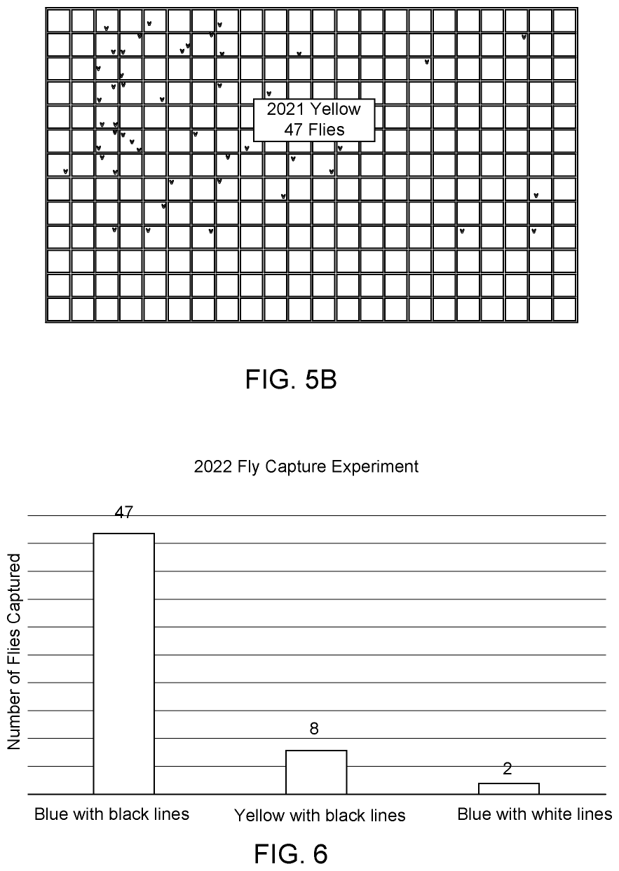

FIG. 5A shows an image of black line pattern over blue background used in the 2021 Capture Experiments.

FIG. 5B shows an image of black line pattern over a yellow background used in the 2021 Capture Experiments.

A 2022 Fly Capture Study on Colored Sticky Boards was done on Sep. 7, 2022, at a screenhouse at the University of Florida, Gainesville, Florida.

About 300 flies were released into an outdoor large screened house (the screened house contained the flies in an approximately 15 by approximately 10 ft area.

The flies were left to acclimatize to the screened house for approximately 1 hour.

Colored sticky boards were hung on one of the screened walls of the room. Boards were either blue with black lines, yellow with black lines, or Black with white lines.

Boards were left to capture flies in the glue for only approximately 30 min, because of a thunderstorm that moved into the area.

Numbers of flies capture in approximately 2 hours were recorded.

A total of 47 flies were caught on the blue background with black lines board.

A total of 8 flies were caught on the yellow background with black lines board,

A total of 2 flies were caught on the black with white lines board.

Comparing Blue with Black lines captured, showed that 5.9 times more flies than yellow with black lines, and 23.5 times more flies than Black with white lines.

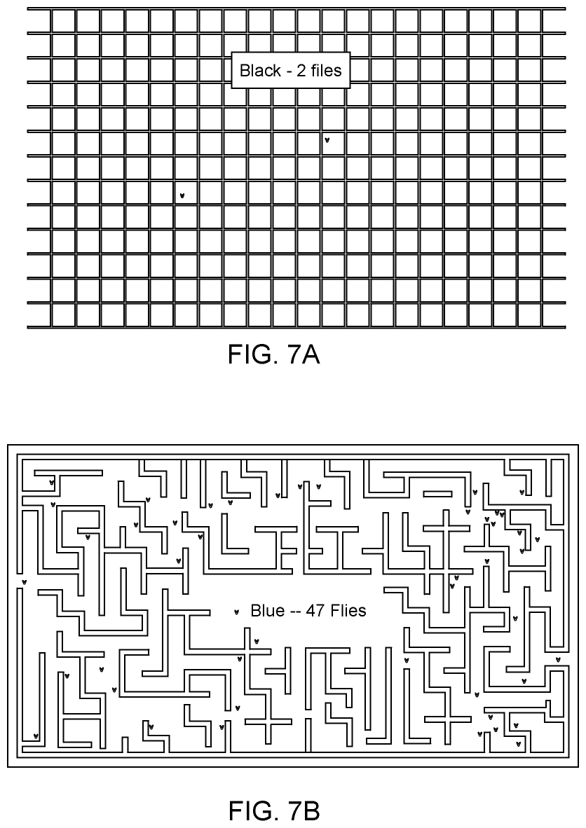

FIG. 6 is a bar graph of the results of a 2022 Fly Capture Experiments.

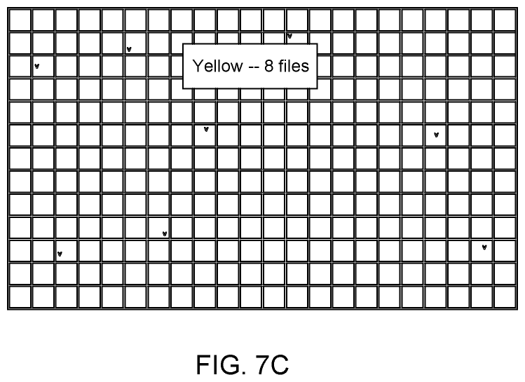

FIG. 7A shows an image of white line pattern over a black background used in the 2022 Capture Experiments.

FIG. 7B shows an image of blue line pattern over a yellow background used in the 2022 Capture Experiments.

FIG. 7C shows an image of black line pattern over a yellow background used in the 2022 Capture Experiments.

From the experiments shown in FIGS. 4-7C, the captured flies landed next to black line patterns over a blue background an average of less than approximately 5 mm from the black line patterns.

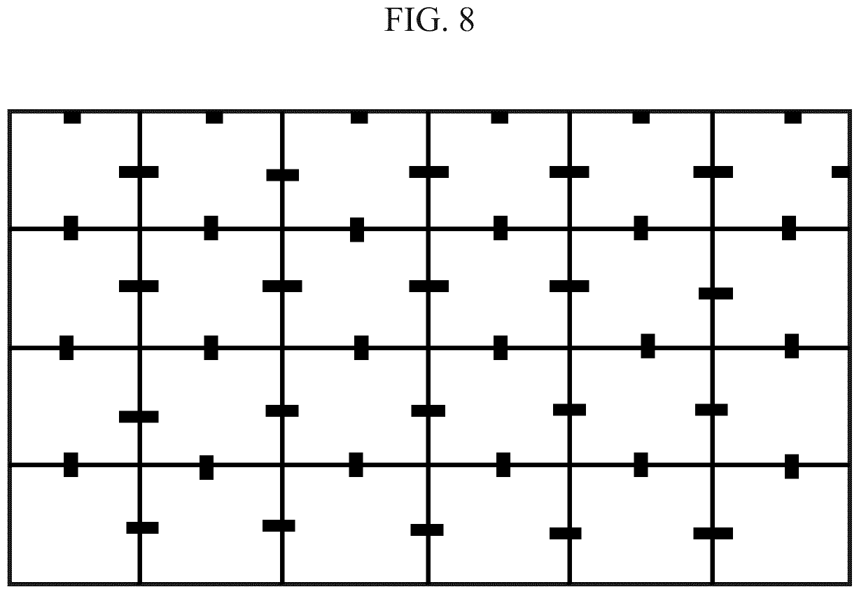

FIG. 8 shows a first embodiment of a feathering crack pattern in black over a blue colored background. This feathering crack pattern covers spaced apart, different size rectangular crack shapes over a grid pattern. The rectangular shape feathers replicate cracks and surface edges which attract the flies to land on. The blue colored background can have a sticky surface, such as previously described, which trap the flies thereon. which attract the flies to land on.

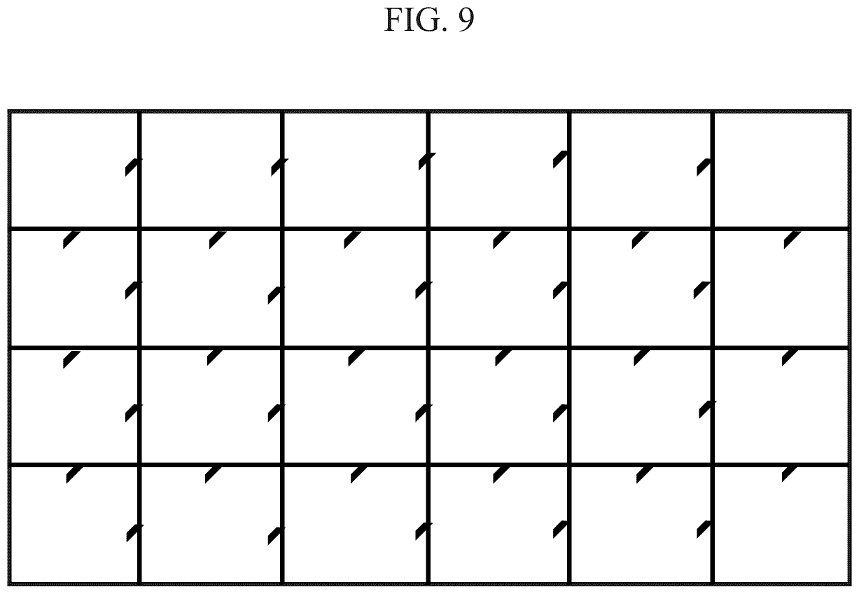

FIG. 9 shows a second embodiment of a feathering crack pattern in black over a blue background. This feathering crack pattern covers spaced apart parallelogram crack shapes over a grid pattern. The parallelogram shape feathers replicate cracks and surface edges. The blue colored background can have a sticky surface, such as previously described, which trap the flies thereon. which attract the flies to land on.

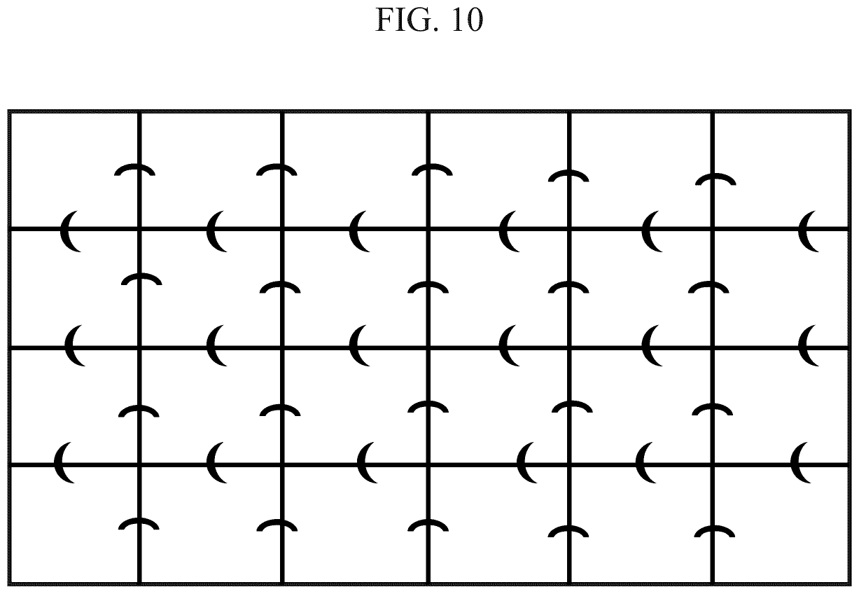

FIG. 10 shows a third embodiment of a feathering crack pattern in black over a blue background. This feathering crack pattern covers spaced apart curve and/or crescent crack shapes over a grid pattern. The curve and/or crescent shape feathers replicate cracks and surface edges. The blue colored background can have a sticky surface, such as previously described, which trap the flies thereon. which attract the flies to land on.

While selected geometric shapes are shown as cracks and surfaces edges to attract flies to land on, other types of geometrical shapes can be used, such as but not limited to circular, semicircular, oval, triangular, cone, pentagon, hexagon, octagon, star, and the like, can be used to replicate cracks and surface edges that attract flies to land thereon.

Referring to FIGS. 8, 9 and 10, the background can be a blue back background with a sticky surface as previously described, wherein the black patterns replicate cracks and surface edges which attract the flies to land thereon.

While an initial blue background with black patterns being applied to the blue background as been previously described, blue backgrounds can be applied as a separate layer.

Blue glue materials, can be applied, such as those used in off-the-shelf products, that can include, but are not limited to ELMERS METALLIC PVA (Polyvinyl Acetate) GLUE, and ELMER'S Glitter Glue Blue which are liquid glues manufactured by Elmer's Products, Inc., Westerville, Ohio. Other types of blue glue that can be used include, but are not limited to UHU magic blue™ manufactured by UHU GmbH & Co. KG of Baden Germany.

A clear fly sticky glue in a liquid form can be used, such as the Catchmaster Bulk Glue manufactured by AP & G Co., INC. of Brooklyn, New York.

Dyes can be added to the clear sticky glue to achieve a color of Pantone 115-5C blue color. The now sticky blue glue does not dry hard, and can remain in a sticky state after being applied to surface.

These types of blue glue can be in liquid form, and can also be applied in a stick form by rubbing a glue stick against a surface.

Off-the-shelf insect glue that can include a blue pigment added to the glue to achieve a Pantone 115-5C blue color.

Alternatively, a non-drying clear photo mounting glue can used, such as but not limited to 3M Photo Mount Spray Adhesive manufactured by 3M COMPANY of St. Paul, Minnesota. The non-drying photo mounting glue can also be a dyed with dyes to achieve a color of Pantone 115-5C blue color. This non-drying blue colored photo mounting glue can also stay in a sticky state after it is applied to a surface.

Alternatively, the clear pressure-sensitive used by 3M for Post-It® by 3M Company may be used, such as the adhesive shown and described in U.S. Pat. No. 5,194,299 to Fry and U.S. Pat. No. 6,063,329 to Miles et al., which are both incorporated by reference in their entirety. This clear adhesive that remains in a sticky state can also be a dyed with dyes to achieve a color of Pantone 115-5C blue color. This non-drying blue colored photo mounting glue will stay in a sticky state after it is applied to a surface.

The blue glue surface layer can be separately applied to the surface of a base layer such as but not limited to a cardboard sheet layer, paper sheet layer, plastic sheet layer, and the like, where the base layer includes black lines in a pattern thereon, as previously shown and described.

With a glue surface applied to the base with the black line patterns, the black line patterns can bleed through the glue surface. As discussed, the glue surface can remain sticky after it has been applied.

Additionally, a peel and stick layer can be applied over the blue glue surface, where the peel and stick layer can be removed when the product is to be used to attract and trap flies.

The invention can also be practiced with a base layer being white with the black line patterns on the white surface. A blue glue layer can then be overlayed over the black line pattern on a white surface, so that the overall surface is visually blue with back line patterns visible from the blue glue overlayer.

An additional version of the invention can be practiced with a blue sticky surface over a base, and separate black line patterns being separately affixed to the blue sticky surface. The black line patterns can be applied by another layer of black line patterns, with each of the vertical and horizontal black lines separated from one another by the sticky blue glue which remains in a sticky state. Next, a peel and stick layer can overlay both the blue sticky surface and the separately affixed black line patterns.

While various sizes of the calendar trap have been described, the dimension sizes can include other sizes, such as but not limited to approximately 3 inches by approximately 3 inches, approximately 4 inches by approximately 4 inches, approximately 4 inches by approximately 6 inches, and the like.

The calendar trap device can be formed into peel and stick pads similar to Post-It® note pads by 3M Company may be used, and further use the adhesive shown and described in U.S. Pat. No. 5,194,299 to Fry and U.S. Pat. No. 6,063,329 to Miles et al., which are both incorporated by reference in their entirety.

Although the preferred embodiments describe fixed surfaces formed with blue sticky surfaces having a color of Pantone 115-5C blue color, over black line patterns, the invention can be practiced by a user with a container of blue liquid glue having a having a color of Pantone 115-5C blue color that can be applied by the user to a surface having black line patterns that bleed through the blue layer. A container can be used to store the blue liquid glue having a color of Pantone 115-5C blue color, where the glue remains in a sticky state after it is applied to a surface.

The container and applier can be similar to the containers, shown and described in U.S. Pat. No. 5,873,669 to Poore et al. and U.S. Pat. No. 6,729,788 to Bouveresse, which are incorporated by reference in their entirety. The container can be part of a kit for the user to apply the sticky blue glue to surfaces on pages of a calendar and the like, in order to form another version of the calendar trap.

The kit of the container of the blue glue having a color of Pantone 115-5C blue color that remains in a sticky state, can be used with calendar images on pages, sheets, and the like. As previously described, on each page/sheet, can be individual dates, and/or individual days of the week, and/or a single week, a single month, a plurality of months, an entire year, and the like. The individual sheets/pages can be covered with separate peel and stick layers, and/or be packaged without separate peel and stick layers, similar to pads of sticky notes, and the like.

Types of calendars pads and displays that can use the overlying blue glue that remains in a sticky state, can include calendars, such as those shown and described in U.S. Pat. No. 4,024,656 to Farnsworth; U.S. Pat. No. 4,250,639 to Tarrant; U.S. Pat. No. 4,342,167 to Stanard; U.S. Pat. No. 5,123,191 to Kim; and U.S. Pat. No. 5,426,876 to Jagoe et al., which are each incorporated by reference in their entirety. Additional calendar pads and displays that can use the overlying blue glue that remains in a sticky state, can include calendars, such as those shown and described in U.S. Published Patent Applications: 2005/0012322 to Clilvered and 2012/0175865 to Meyer et al., which are each incorporated by reference in their entirety. Transparent sheet layers can be used as a peel and stick layer to cover each of the calendar pages.

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

The term “approximately” is similar to the term “about” and can be +/−10% of the amount referenced. Additionally, preferred amounts and ranges can include the amounts and ranges referenced without the prefix of being approximately.

While the invention has been described, disclosed, illustrated and shown in various terms of certain embodiments or modifications which it has presumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

We claim:

1. A rectangular shaped fly trap device for trapping live flies without toxicants, comprising:
a plurality of single sheets stacked together having a rectangular shape configuration;
each of the single sheets having a front side and a rear side, the front side of each of the single sheets having black line patterns on a black grid over a solid colored background; and
a layer of blue glue overlaying the front side of each sheet forming a blue sticky surface on the front side of each sheet, wherein each sheet with the sticky surface and black line pattern is exposed for a selected period of time, and then discarded.

2. The rectangular shaped fly trap device of claim 1, wherein the black line patterns include black geometrical shapes selected from the group consisting of different size rectangle crack shapes, parallelogram crack shapes, curve and crescent crack shapes.

3. The rectangular shaped fly trap device of claim 1, further comprising:
a peel and stick cover sheet overlaying the front side of each sheet, wherein removing the peel and stick cover sheet, exposes the blue sticky surface, wherein each sheet with the sticky surface and black line pattern is exposed for a selected period of time, and then discarded.

4. The rectangular shaped fly trap device of claim 1, wherein the layer of blue glue is selected from the group consisting of blue liquid glue, blue glue from a blue stick of glue, glue with blue glitter, and non-drying photo mount glue.

5. The rectangular shaped fly trap device of claim 1, wherein the layer of blue glue is formed from liquid glue with dyes having a color of Pantone 115-5C blue color, wherein the liquid blue glue maintains a sticky state after being applied.

6. A rectangular shaped fly trap device for trapping live flies without toxicants, comprising:
a plurality of single sheets stacked together having a rectangular shape configuration;
each of the single sheets having a front side and a rear side, the front side of each of the single having a layer of blue glue overlaying the front side forming a blue sticky surface on the front side of each sheet; and
black line patterns on a black grid overlaying the layer of blue glue, wherein each sheet with the blue sticky surface and black line pattern is exposed for a selected period of time, and then discarded.

7. The rectangular shaped fly trap device of claim 6, wherein the black line patterns include black geometrical shapes selected from the group consisting of different size rectangle crack shapes, parallelogram crack shapes, curve and crescent crack shapes.

8. The rectangular shaped fly trap device of claim 6, further comprising:
a peel and stick cover sheet overlaying the front side of each sheet, wherein removing the peel and stick cover sheet, exposes the blue sticky surface, wherein each sheet with the sticky surface and black line pattern is exposed for a selected period of time, and then discarded.

9. The rectangular shaped fly trap device of claim 6, wherein the layer of blue glue is selected from the group consisting of blue liquid glue, blue glue from a blue stick of glue, glue with blue glitter, and non-drying photo mount glue.

10. The rectangular shaped fly trap device of claim 6, wherein the layer of blue glue is formed from liquid glue with dyes having a color of Pantone 115-5C blue color wherein the liquid blue glue maintains a sticky state after being applied.

11. A method of forming a fly trap device, comprising the steps of:
applying black line patterns on a black grid over a solid colored background of a front side of a single rectangular sheet; and
applying a blue glue layer to the front side of a single rectangular sheet, wherein the glue layer remains in a sticky state after being applied to the front side of the single rectangular sheet, wherein the liquid blue glue maintains a sticky state after being applied.

12. The method of forming the fly trap of claim 11, wherein the applying the blue glue layer step includes the step of:
selecting the blue glue layer from the group consisting of blue liquid glue, blue glue from a blue stick of glue, glue with blue glitter, and non-drying photo mount glue.

13. The method of claim 11, wherein the applying the blue color layer step includes the step of: selecting the blue glue layer from a liquid glue with dyes having a color of Pantone 115-5C blue color. wherein the liquid blue glue maintains a sticky state after being applied.

14. The method of claim 11, further comprising the step of:
applying a peel and stick cover sheet overlaying the front side of the single rectangular sheet, wherein removing the peel and stick cover sheet, exposes the blue sticky surface for a selected period of time, and then discarded.

15. The method of claim 11, further wherein the black line patterns include the step of:
providing black geometrical shapes selected from the group consisting of different size rectangle crack shapes, parallelogram crack shapes, curve and crescent crack shapes.
